(19) United States
(12) Patent Application Publication
(10) Pub. No.: US 2005/0058967 A1
(43) Pub. Date: Mar. 17, 2005

(54) Dressmaking kit shop and mail-order system

(75) Inventors: Kenichi Ayukawa, Funabashi (JP); Yuichi Sato, Funabashi (JP)

Correspondence Address: GREER, BURNS & CRAIN, 300 S WACKER DR, 25TH FLOOR, CHICAGO, IL, 60606, US

(73) Assignee: SATO SAMPLING ROOM CO., LTD

(21) Appl. No.: 10/662,766

(22) Filed: Sep. 15, 2003

(51) Int. Cl. G09B 19/20; G06F 17/60

(52) U.S. Cl. 434/95; 434/395

(57) ABSTRACT

In a dressmaking kit shop, textile shelves storing textiles, shelves storing dressmaking kits, a sewing machine and a replay device replaying a storage medium, such as a video cassette tape, a DVD, etc., for learning how to sew using the dressmaking kit are located. Customers can experience sewing while watching the pictures of a sewing method recorded on the storage medium by the replay device.

### BACKGROUND OF THE INVENTION

1. Field of the Invention

The present invention relates to a shop that sells dressmaking kits, in particular it relates to a space-saving dressmaking kit shop.

2. Description of the Related Art

Dressmaking population has drastically declined. For example, in many colleges and high schools, dressmaking classes and home economics classes are no longer available due to the shortage of students.

Therefore, it is desired to make people interested in dressmaking and to prevent their numbers from decreasing.

For this reason, dressmaking schools have been opened and a sewing method has been taught using a sewing machine. However, even a small-scaled dressmaking school requires a floor space of at least 33 m². Therefore, it cannot be easily opened in terms of a floor space. The opening cost of such a school is also high.

If the space needed to open such a dressmaking school is limited, its advertisement effect depends on the location of such a dressmaking school.

### SUMMARY OF THE INVENTION

It is an object of the present invention to make customers interested in dressmaking and to provide a shop in which customers can experience sewing on the spot.

In one aspect of the present invention, the dressmaking kit shop is a dressmaking kit shop at which customers can experience sewing and which sells dressmaking kits. The dressmaking kit shop comprises dressmaking kit shelves, a sewing machine mounted on a stand and a replay device replaying a sewing method recorded on a storage medium.

In this case, a dressmaking kit, a sewing machine and a replay device replaying a storage medium which records a method for sewing clothes of prescribed designs (for example, a T-shirt, training wear, etc.) are located at the dressmaking kit shop.

By adopting such a configuration, a dressmaking kit shop can be opened in a small area of, for example, 3.3 m² to 16.5 m².

The area of the dressmaking kit shop is not limited to the value described above. For the storage medium recording the sewing method, a video cassette tape, a DVD, or the like is used.

Customers can experience sewing using the sewing machine, etc., by replaying the storage medium that records a sewing method by the replay device.

Thus, making customers interested in dressmaking, and leading them to purchase, for example, dressmaking kits, textiles, etc.

Furthermore, since the area of the dressmaking kit shop requires only a small floor space, it can be opened even in a place where a lot of people gather (for example, a mass merchandiser), thereby being also capable of improving the advertisement effect of an affiliated dressmaking school. Specifically, customers can know the existence of a dressmaking school through the sewing experience at the dressmaking kit shop. Alternatively, such a role can be shared with a dressmaking kit shop and a dressmaking school as follows. That is, T-shirts, training wear, etc., which can be easily sewn, are sewn in a dressmaking kit shop, and front-opened cardigans, etc., which require a more complex process, are sewn in a dressmaking school. A dressmaking school can also be temporarily opened in the general floor space of a mass merchandiser, etc.

In another aspect of the present invention, the dressmaking kit shop further comprises textile shelves storing textiles. A customer that experiences sewing in a dressmaking shop has a desire to try a plurality of different textiles for one design. The textile shelves are provided to satisfy such a desire of a customer.

In another aspect of the present invention, the dressmaking kit shop further comprises storage shelves storing either a sewing machine or a storage medium.

The dressmaking kit shop can also sell textiles stored on the textile shelves. It can also sell a storage medium, which records a sewing method. It can also sell a sewing machine.

In another aspect of the present invention, the dressmaking kit includes at least one of textiles, dress patterns, and sewing manuals.

In another aspect of the present invention, dressmaking kits to be sold at such a dressmaking kit shop are sold through a network.

### BRIEF DESCRIPTION OF THE DRAWINGS

FIG. 1 is the perspective illustration of a dressmaking kit shop in the first preferred embodiment;

FIG. 2 is the top view of a dressmaking kit shop in the first preferred embodiment;

FIG. 3A is a first layout variation of a dressmaking kit shop in the first preferred embodiment;

FIG. 3B is a second layout variation of a dressmaking kit shop in the first preferred embodiment; and

FIG. 4 shows the rough configuration of a mail-order system in the second preferred embodiment.

### DESCRIPTION OF THE PREFERRED EMBODIMENTS

The preferred embodiments of the present invention are described below with reference to the drawings.

### The First Preferred Embodiment

In this preferred embodiment, a customer visits a dressmaking kit shop and experiences sewing. Then, the customer purchases goods sold at the dressmaking kit shop, if necessary.

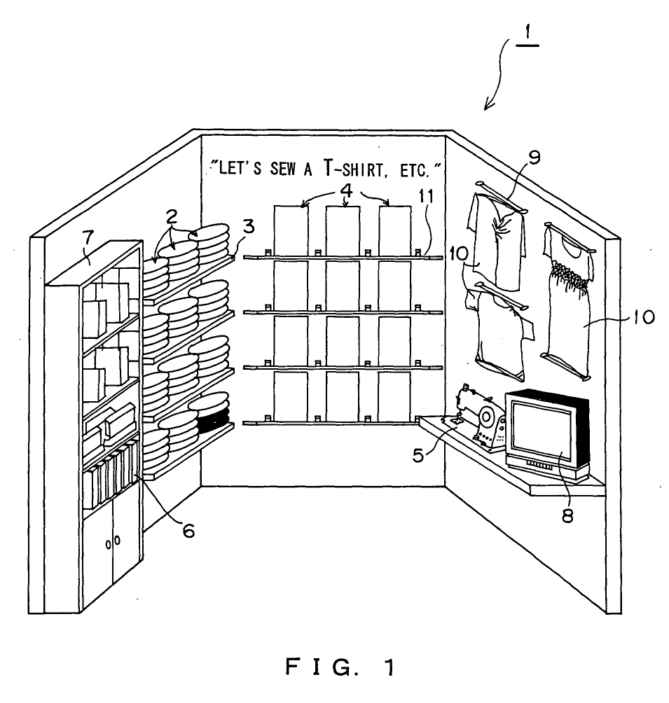

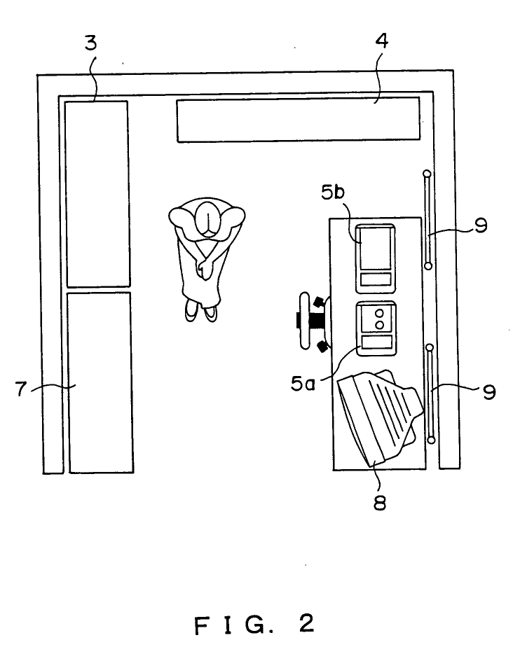

FIG. 1 is the perspective illustration of the dressmaking kit shop of this preferred embodiment. FIG. 2 is a top view of this dressmaking kit shop.

As shown in FIG. 1, the dressmaking kit shop 1 of this preferred embodiment comprises textile shelves 3 storing textiles 2, shelves 11 storing dressmaking kits 4, a sewing machine 5 and a replay device 8 replaying storage media 6, such as video cassette tapes, DVDS, etc., which record how to sew.

The textile shelves 3 store textiles. When a customer wants to sew clothes of a prescribed design using several different textiles, the customer selects from the different textiles and sews the clothes of the prescribed design using the textiles. Then, the customer checks the finished clothes.

Instead of a customer, for example, a clerk of a dressmaking kit shop can also sew clothes in order to show how to sew clothes of a prescribed design by the sewing machine 5 using textiles 2 stored on the textile shelves 3 and textiles included in the dressmaking kit 4.

For textiles stored on textile shelves, pre-cut or uncut textiles can be used.

The dressmaking shop 1 does not necessarily comprise textile shelves 3.

Finished sample works 10 can also be displayed on a display net 9.

It is preferable for the dressmaking kit shop 1 to comprise shelves 7 storing the storage media 6. The shelves 7 can also store books on how to sew, the sewing machine 5 and etc. in addition to the storage media 6.

As shown in FIG. 2, if stretchable textiles are sewn, it is preferable to use a lock sewing machine 5a for seaming and a straight-line sewing machine 5b for the post-process of seaming, as the sewing machine 5. The sewing machine for the post-process of seaming is not limited to the straight-line sewing machine 5b.

The dressmaking kit 4 sold at the dressmaking kit shop 1 comprises textiles, dress patterns and manuals on how to sew. The contents of the manuals on how to sew are almost the same as those of the storage media. However, the contents of the manuals can also be somewhat simplified. The textiles contained in the dressmaking kit can be pre-cut or uncut textiles.

Matching a design with textiles suitable for the design is essential for the learning of dressmaking. However, conventionally, such matching of a design with textile suitable for the design has not been made. Taking such matching into consideration, the dressmaking kit 4 contains textiles suitable for each design (for example, T-shirts, training wear, etc.).

The operation of the dressmaking kit shop of this preferred embodiment is described below.

A customer is interested in dressmaking and visits this dressmaking kit shop 1. Then, the customer watches the pictures stored in a storage medium 6, such as a video cassette tape, a DVD, etc., replayed by the replay device 8, gets interested in dressmaking or feel that a T-shirt or training wear is easy to sew, and become anxious to sew a T-shirt or training wear.

In this preferred embodiment, customers can experience sewing on the spot. This is because in the dressmaking kit shop of this preferred embodiment, dressmaking kits and a sewing machine are provided in a small space, and that a customer can sew a T-shirt or training wear while watching a video cassette tape (or reading a book on how to sew) on the spot.

The dressmaking kit shop of this preferred embodiment can be opened in a small space. For example, it can even be opened in a place with a great advertisement effect, such as a mass-merchandiser, etc. Therefore, not only the advertisement effect of a dressmaking kit shop, but also that of its affiliated dressmaking school are great.

The sewing process recorded on a video cassette tape is briefly described below.

It is assumed that in a dressmaking kit shop, a customer sews a T-shirt, using an expandable textile, such as knit, etc. The customer seams the respective shoulder line cut edges of a front body and a rear body by a lock sewing machine 5a. In the case of expandable textiles, such as knit, etc., an original pattern cannot be sustained without using a lock sewing machine.

For example, a T-shirt is sewn through such a sewing process.

A design is not limited to a T-shirt. Generally, there is basically no need to simplify a sewing process recorded on the storage medium 6. However, taking into consideration the fact that most customers lack experience sewing, it is preferable to simplify the sewing process. For example, when seaming front and rear bodies to be seamed by a lock sewing machine, by temporarily fixing the bodies by a freely detachable/attachable fixtures, such as clothes pins, etc., the sewing process can be simplified.

If a customer becomes at a loss how to sew, the customer can also seek guidance from the clerk (salesperson) of a dressmaking kit shop.

If the dressmaking kit shop of this preferred embodiment is franchised, an instructor dispatched from its franchise headquarters can also work as its clerk. In that case, customers can seek guidance from the instructor.

The franchise headquarters can also limit the education target of the clerks of dressmaking kit shops to designs for a T-shirt, training wear, etc., that can be sewn in a relatively simple process.

Furthermore, later, customers can also visit the affiliated dressmaking school of the dressmaking kit shop and experience sewing there. In this case, dressmaking kit purchasers can also be guided with priority.

The dressmaking kit shop can also sell books on how to sew knit, storage media, such as video cassette tapes, DVDs, etc., which record how to sew knit, textiles stored in textile shelves, and the like, in addition to dressmaking kits.

Furthermore, the dressmaking kit shop of this preferred embodiment can also sell designs made there using the sewing machine by the clerks and instructor of the dressmaking kit shop that have prescribed skills. Alternatively, the dressmaking kit shop of this preferred embodiment can sell designs made in other places.

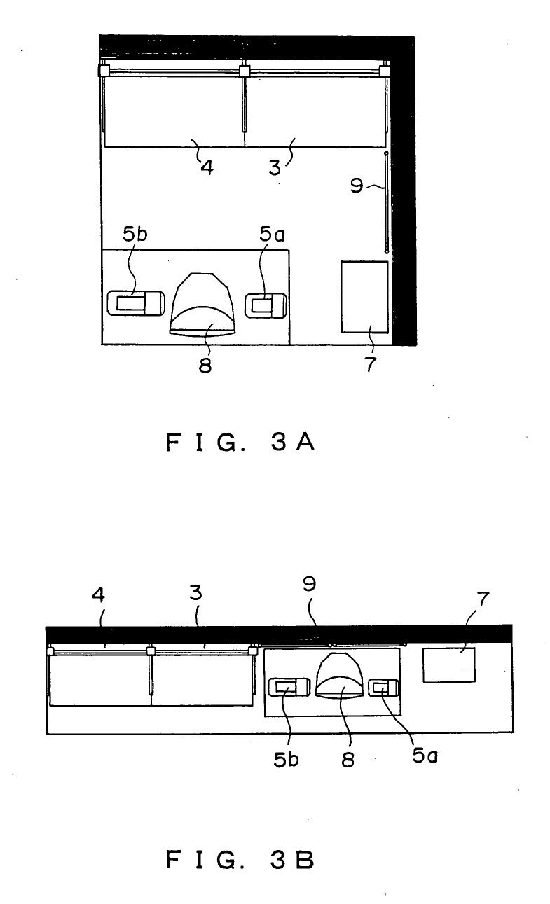

The layout of a dressmaking kit shop is not limited to that shown in FIG. 1. FIGS. 3A and 3B show variations of the layout.

### The Second Preferred Embodiment

Although in the first preferred embodiment, customers visit a dressmaking kit shop and purchase dressmaking kits, in this preferred embodiment, customers purchase goods, such as dressmaking kit, etc., by a mail order through a network, such as the Internet, etc.

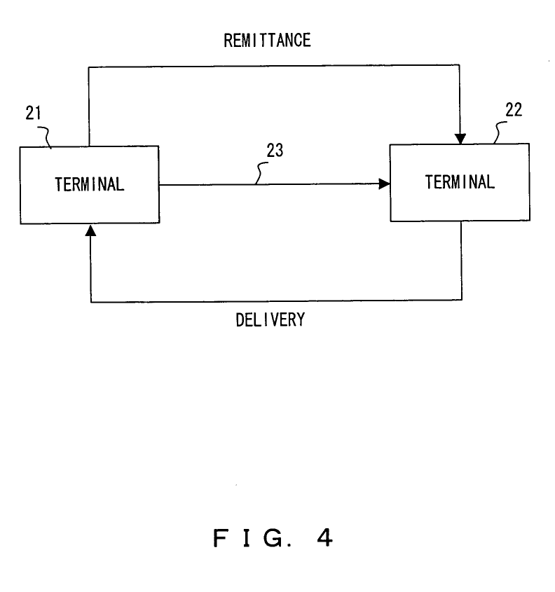

FIG. 4 shows the rough configuration of this mail-order system. In FIG. 4, a customer at a terminal 21, being the purchaser of goods, is connected to a seller of goods at a terminal 22 through a network. The seller presents the catalog of goods on a homepage, etc., on the Internet. This catalog of goods includes dressmaking kits, books on how to sew, storage media, such as video cassette tapes, DVDs, etc., which record how to sew, textiles, and the like. The customer, being the purchaser of goods accesses the homepage and issues a purchase request 23. Then, a sales agreement is concluded. Then, the customer sends the price of the purchased goods to the seller, and the seller delivers the purchased goods to the customer.

As described above, in the present invention, the dressmaking kit shop can be opened in a small space. For example, it can be opened in a floor space of 3.3 m² to 16.5 m².

The space is not limited to the value.

Since the dressmaking kit shop of the present invention requires only a small space, such shops can be easily distributed.

Since the dressmaking kit shop of the present invention comprises a sewing machine and a replay device replaying how to sew recorded on a storage medium, such as a video cassette tape, a DVD, etc., customers can experience sewing on the spot.

Furthermore, since the dressmaking kit shop requires only a small space, it can be opened even in a place with a great advertisement effect, such as a mass-merchandiser, etc. Therefore, not only the advertisement effect of a dressmaking kit shop, but also that of its affiliated dressmaking school are great.

1. A dressmaking kit shop in which sewing can be experienced and which sells dressmaking kits, comprising:
a dressmaking kit shelf storing the dressmaking kit;
a sewing machine mounted on a stand; and
a replay device replaying a sewing method, which is recorded on a storage medium.

2. The dressmaking kit shop according to claim 1, further comprising:
a textile shelf storing textiles.

3. The dressmaking kit shop according to claim 1, further comprising:
a shelf storing at least one of the sewing machine and storage medium.

4. The dressmaking kit shop according to claim 2, which sells textiles stored in the textile shelf.

5. The dressmaking kit shop according to claim 1, which sells the storage medium.

6. The dressmaking kit shop according to claim 1, which sells the sewing machine.

7. The dressmaking kit shop according to claim 1, wherein
said dressmaking kit includes at least one of textiles, marking drawings and manuals on a sewing procedure.

8. A mail-order system for selling goods through a network organized by connecting terminal sets with each other through communication lines, wherein
goods to be sold include at least one of textiles, marking drawings, and manuals on a sewing procedure.

9. Dressmaking kit selling facilities established to sell dressmaking kits, comprising:
replay means for replaying a storage medium, which records a sewing method;
sewing means for sewing, which is installed in a place where pictures replayed by the replay means can be watched; and
storage means for storing dressmaking kits, including textiles used by the sewing means when sewing.
